(19) United States
(12) Patent Application Publication
(10) Pub. No.: US 2014/0122038 A1
(43) Pub. Date: May 1, 2014

(54) PRESSURE BASED ARTERIAL FAILURE PREDICTOR

(71) Applicant: Kambix Innovations, LLC, Albuquerque, NM (US)

(72) Inventors: Kambiz Vafai, Mission Viejo, CA (US); Pannathai Khamdaengyodtai, Chiang Mai (TH); Phrut Sakulchangsatjatai, Chiang Mai (TH); Pradit Terdtoon, Chiang Mai (TH)

(73) Assignee: Kambix Innovations, LLC.

(21) Appl. No.: 14/058,735

(22) Filed: Oct. 21, 2013

Related U.S. Application Data
(60) Provisional application No. 61/718,840, filed on Oct. 26, 2012.

(51) Int. Cl. G06F 19/00

(52) U.S. Cl. CPC G06F 19/3437
USPC 703/2

(57) ABSTRACT

A three-dimensional multilayer model of mechanical response for analyzing the effect of pressure on arterial failure. The three-dimensional effects are incorporated within five-concentric axisymmetric layers while incorporating the nonlinear elastic characteristics under combined extension and inflation. Constitutive equations for fiber-reinforced material are employed for layers such as intima, media, and adventitia, and an isotropic material model is employed for layers such as endothelium and internal elastic lamina. The three-dimensional five-layer model can be utilized to model propagated rupture area of the arterial wall. Required parameters for each layer are obtained by using nonlinear least square method fitted to in vivo non-invasive experimental data of human artery and the effects of pressure on arterial failure are examined.

### CROSS-REFERENCE TO PROVISIONAL PATENT APPLICATION

This patent application claims the benefit under 35 U.S.C. §119(e) of U.S. Provisional Application Ser. No. 61/718,840 entitled “Effects of Pressure on Arterial Failure,” which was filed on Oct. 26, 2012 and is incorporated herein by reference in its entirety.

### FIELD OF THE INVENTION

Embodiments are generally related to the cardiovascular system. Embodiments also relate to a three-dimensional multilayer model of mechanical response for analyzing effect of pressure on arterial failure. Embodiments additionally relate to a method and system for predicting propagated rupture area of the arterial wall coupled with blood flow in the lumen.

### BACKGROUND

A cardiovascular system encompasses a pump (heart), a delivery network (arteries), and a return network (veins) to return the blood back to the pump to complete the cycle. The pressure resulting from the blood flow acts on the endothelium cells of an artery. The endothelium cells respond to stress and strain by inflation or contraction and extension. Mechanical properties of stress and strain of the arterial wall have received more attention in recent years.

Several constitutive models have been proposed (Holzapfel et al., 2000; Delfino et al., 1997; Fung, 1990, 1997, 1993). Monolayer homogenous arterial wall is the simplest model to represent an artery. However, it is well known that the arterial wall is a non-homogeneous material. A better approach is to model heterogeneity of the arterial wall by considering it as a multi-layer structure while incorporating its architecture and its different layers, namely endothelium, intima, internal elastic lamina, media and adventitia. The pressure acting on the inside surface of arterial wall is caused by the lumen. While there are several definitions of stress and strain (Fung, 1969, 1994, 2001), the Cauchy stress and the Green-Lagrange strain are widely used to refer to the force acting on the deformed area and the ratio of inflation and extension.

A biological tissue can be subjected to chemical changes, which can be effectively represented by changes in the stress and strain. By monitoring stress and strain during a cyclic load experiment, the response of an artery can be assessed during the loading and unloading processes (Holzapfel et al., 2004b).

Therefore, a need exists for improved system and method that analyses stress and strain behavior of an arterial wall incorporating elastic deformation under a pressure load. Also, a need exists for a three-dimensional five-layer model for studying the effect of pressure on the arterial failure.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide cardiovascular system.

It is another aspect of the disclosed embodiments to provide three-dimensional multilayer model of mechanical response for analyzing effect of pressure on arterial failure.

It is a further aspect of the present invention to provide a method and system for predicting propagated rupture area of the arterial wall coupled with blood flow in the lumen.

The aforementioned aspects and other objectives and advantages can now be achieved as described herein. The multilayer arterial wall is considered to be composed of five different layers. The three-dimensional effects are incorporated within the five-concentric axisymmetric layers while incorporating the nonlinear elastic characteristics under combined extension and inflation. Constitutive equations for fiber-reinforced material are employed for three of the major layers such as intima, media and adventitia, and an isotropic material model is employed for the other two layers such endothelium and internal elastic lamina.

The three-dimensional five-layer model can be utilized to model propagated rupture area of the arterial wall. Required parameters for each layer are obtained by using nonlinear least square method fitted to in vivo non-invasive experimental data of human artery and the effects of pressure on arterial failure are examined. The solutions from the computational model are compared with previous studies and good agreements are observed. Local stresses and strain distributions across the deformed arterial wall are illustrated and consequently the rupture area is predicted by varying luminal pressure in the physiological range and beyond. The effects of pressure on the arterial failure have been interpreted based on this comprehensive three-dimensional five-layer arterial wall model. The present invention employs two constitutive equations and incorporates a five-layer arterial wall model in three-dimensions based on in vivo non-invasive experimental data for a human artery.

It is to be understood that both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention and together with the description serve to explain the principles of the invention.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIGS. 1A and 1B illustrate a schematic illustration of an artery and imposed boundary conditions, in accordance with the disclosed embodiments;

FIG. 1C illustrates a graph showing pressure profile along a cardiac cycle for a human carotid artery, in accordance with the disclosed embodiments;

FIG. 1D illustrates a graph showing the diameter profile along a cardiac cycle for a human carotid artery, in accordance with the disclosed embodiments;

FIGS. 2A-2D illustrate graphs showing comparison of luminal pressure versus inside and outside radii for a one layer artery with prior works listed in Table 4, Case 1A, Case 1B, Case 1C, and Case 1D, respectively, in accordance with the disclosed embodiments;

FIGS. 3A-3E illustrate graphs showing comparison of luminal pressure versus inside and outside radii and the principal Cauchy stresses across arterial wall for a two-layer artery with prior works listed in Table 4, Case 2A, Case 2B, Case 2C, Case 2D, and Case 2E, respectively, in accordance with the disclosed embodiments;

FIGS. 4A-4F illustrate graphs showing rupture characteristics of an arterial wall based on utilizing strain as a criterion with wall deformation in the r-θ plane at luminal pressure of 16.0, 18.7, 21.3, 24.0, 26.7, and 33.3 kPa, respectively, in accordance with the disclosed embodiments;

FIGS. 5A-5F illustrate graphs showing rupture characteristics of an arterial wall based on using stress and strain as a criterion with wall deformation in the r-θ plane at luminal pressure of 16.0, 18.7, 21.3, 24.0, 26.7, and 33.3 kPa, respectively, in accordance with the disclosed embodiments; and

FIGS. 6A-6F illustrate graphs showing percentage risk of rupture of an arterial wall based on using stress and strain as a criterion with risk percentage of rupture in the r-θ plane at luminal of 16.0, 18.7, 21.3, 24.0, 26.7, and 33.3 kPa, respectively, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The following Table 1 provides the various symbols and meanings used in this section:

TABLE 1

| | |
|---|---|
| A | Structure tensor of fiber direction |
| a | Acceleration vector |
| aₒ | Fiber direction vector |
| b | The left Cauchy Green tensor |
| C | The right Cauchy Green tensor |
| c | Stress-like parameter of isotropic term |
| DBP | Diastolic blood pressure |
| E | The Green-Lagrange strain tensor |
| F | The deformation gradient tensor |
| f | The body force tensor of blood |
| G | The body force tensor of arterial wall |
| H | Thickness of arterial layer |
| I | Identity tensor |
| I | Principal invariant |
| k₁ | Stress-like parameter of anisotropic term |
| k₂ | Dimensionless parameter of anisotropic term |
| L | Overall longitudinal length in reference configuration |
| MBP | Mean blood pressure |
| MSE | Mean square error |
| N | Number of experimental data points |
| P | Lagrange multiplier |
| p | Luminal pressure |
| R | Radial position in reference configuration |
| r | Radial position in deformed configuration |
| rₚ | The Pearson product moment correlation coefficient |
| s | The second Piola-Kirchhoff stress tensor |
| SBP | Systolic blood pressure |
| T | Period of cardiac time |
| t | Time |
| Uₒ | Reference bulk inflow velocity |
| u | Velocity component |
| v | Velocity vector |
| X | The position vector in reference configuration |
| x | The position vector in deformed configuration |
| Z | Longitudinal position in reference configuration |
| z | Longitudinal position in deformed configuration |

Greek symbols

| | |
|---|---|
| β | Angle of collagen fibers |
| δ | Parameter for fluctuation of pulsatile flow |
| ζ | Fold value of mean |
| Θ | Angular position in reference configuration |
| θ | Angular position in deformed configuration |
| λ | Stretch ratio |
| μ | Dynamic viscosity of blood |
| ξ | Fold value of amplitude |
| ρ | Density of arterial wall |
| σ | The Cauchy stress tensor |
| Φ | Opening angle |
| ψ | The strain energy function |
| Ω | The deformed configuration |
| Ωₒ | The reference configuration |

Superscript

| | |
|---|---|
| - | Deviator component |
| * | Normalized value |

Subscript

| | |
|---|---|
| adv | Adventitia |
| end | Endothelium |
| i | Inside |
| iel | Internal elastic lamina |
| int | Intima |
| j | Arterial layer |
| med | Media |
| o | Outside |
| v | Equivalent |
| vol | Volumetric component |
| z | Longitudinal direction |

Other symbol

| | |
|---|---|
| Aₒ | The average height above the abscissa |
| A_{J} | The height of the oscillation in terms of cosine |
| B_{J} | The height of the oscillation in terms of sine |
| ∇ | Gradient operator |

The following Table 2 provides parameters A_{J} and B_{J} in units of Pascal.

TABLE 2

| A_{J} | | | | | | B_{J} | | | | | |
|---|---|---|---|---|---|---|---|---|---|---|---|
| A₁ | −307.802 | A₁₁ | −8.0677 | A₂₁ | −14.8198 | B₁ | 2472.354 | B₁₁ | 6.7722 | B₂₁ | −0.7861 |
| A₂ | −1152.17 | A₁₂ | 44.5415 | A₂₂ | −35.7354 | B₂ | 899.1454 | B₁₂ | −21.8575 | B₂₂ | 4.3848 |
| A₃ | −904.308 | A₁₃ | 22.2471 | A₂₃ | −5.9142 | B₃ | 141.6018 | B₁₃ | 40.6469 | B₂₃ | −19.529 |
| A₄ | −472.175 | A₁₄ | −30.1193 | A₂₄ | 4.3074 | B₄ | −162.328 | B₁₄ | −5.9916 | B₂₄ | −17.2017 |
| A₅ | −376.189 | A₁₅ | 18.2471 | A₂₅ | −1.4468 | B₅ | −319.284 | B₁₅ | −3.3656 | B₂₅ | −20.3007 |
| A₆ | −12.2606 | A₁₆ | 21.6265 | A₂₆ | 22.4666 | B₆ | −490.187 | B₁₆ | 33.2005 | B₂₆ | −15.6279 |
| A₇ | 196.7156 | A₁₇ | 9.0006 | A₂₇ | 14.0872 | B₇ | −193.917 | B₁₇ | 11.1883 | B₂₇ | 6.0502 |
| A₈ | 93.4258 | A₁₈ | 7.895 | A₂₈ | 8.5244 | B₈ | −52.9216 | B₁₈ | 21.7935 | B₂₈ | −2.0939 |
| A₉ | 76.1842 | A₁₉ | −14.0034 | A₂₉ | 8.0986 | B₉ | −44.6953 | B₁₉ | 37.0081 | B₂₉ | −0.6531 |
| A₁₀ | 70.6487 | A₂₀ | −20.9844 | A₃₀ | 6.8244 | B₁₀ | 58.292 | B₂₀ | 7.7842 | B₃₀ | 9.3357 |

The following Table 3 provides the ultimate tensile stress and associated ultimate stretch for intima, media, and adventitia.

TABLE 3

| | | Ultimate tensile | |
|---|---|---|---|
| Layer | Direction | stress (kPa) | Ultimate stretch |
| Adventitia | Circumferential direction | 1031.6 | 1.44 |
| | Longitudinal direction | 951.8 | 1.353 |
| Media | Circumferential direction | 202 | 1.27 |
| | Longitudinal direction | 188.8 | 1.536 |
| Intima | Circumferential direction | 488.6 | 1.331 |
| | Longitudinal direction | 943.7 | 1.255 |

Table 4 provides a list of comparisons with present computational model, specifying the number of layers, source of comparison and the constitutive equation

TABLE 4

| | | Number | Source of | Constitutive | |
|---|---|---|---|---|---|
| FIG. | Case | of layers | comparison | equation | Utilized parameters |
| 2A | 1A | 1 | Holzapfel et al. | Delfino et al. | Artery; a = 44.2 kPa, |
| | | | (2000) | (1997) | b = 16.7 |
| 2B | 1B | 1 | Holzapfel et al. | Fung's type | Artery; c = 26.95 kPa, |
| | | | (2000) | | b₁ = 0.9925, b₂ = 0.4180, |
| | | | | | b₃ = 0.0089, b₄ = 0.0749, |
| | | | | | b₅ = 0.029, b₆ = 0.0193, |
| | | | | | b₇ = 5.000 |
| 2C | 1C | 1 | Sokolis (2010) | Fung's type | Esophagus; c = 2.0934 kPa, |
| | | | | | b₁ = 0.783, b₂ = 7.385, |
| | | | | | b₄ = 0.611 |
| 2D | 1D | 1 | von Maltzahn | Fung's type | Artery; c = 2.4657*2 kPa, |
| | | | et al. (1984) | | b₁ = 0.1499, b₂ = 1.6409, |
| | | | | | b₄ = 0.0028/2 |
| 3A | 2A | 2 | Holzapfel et al. | Holzapfel et al. | Media; c = 3.000 kPa, |
| | | | (2000) | (2000) | k₁ = 2.3632 kPa, k₂ = 0.8393 |
| | | | | | Adventitia; c = 0.3000 kPa, |
| | | | | | k₁ = 0.5620 kPa, k₂ = 0.7112 |
| 3B | 2B | 2 | Sokolis (2010) | Fung's type | Mucosa-submucosa; |
| | | | | | c = 1974.4 Pa, b₁ = 3.296, |
| | | | | | b₂ = 11.529, b₄ = 1.847 |
| | | | | | Muscle; c = 1012.6 Pa, |
| | | | | | b₁ = 0.568, b₂ = 5.197, |
| | | | | | b₄ = 0.360 |
| 3C | 2C | 2 | Maltzahn et al. | Fung's type | Media; c = 2.4657*2 kPa, |
| | | | (1984) | | b₁ = 0.1499, b₂ = 1.6409, |
| | | | | | b₄ = 0.0028/2 |
| | | | | | Adventitia; c = 9.1140*2 kPa, |
| | | | | | b₁ = 0.1939, b₂ = 1.2601, |
| | | | | | b₄ = 0.7759/2 |
| 3D | 2D | 2 | Sokolis (2010) | Fung's type | Mucosa-submucosa; |
| | | | | | c = 2406.1 Pa, b₁ = 2.220, |
| | | | | | b₂ = 10.229, b₄ = 1.747 |
| | | | | | Muscle; c = 1012.6 Pa, |
| | | | | | b₁ = 0.568, b₂ = 5.197, |
| | | | | | b₄ = 0.360 |
| 3E | 2E | 2 | Holzapfel et al. | Holzapfel et al. | Media; c = 3.000 kPa, |
| | | | (2000) | (2000) | k₁ = 2.3632 kPa, k₂ = 0.8393 |
| | | | | | Adventitia; c = 0.3000 kPa, |
| | | | | | k₁ = 0.5620 kPa, k₂ = 0.7112 |

NOTE:
$Strain energy function of Delfino et al . ( 1997 ) , \overline{ψ} = \frac{a}{b} \{ exp ( \frac{b}{2} ( {\overline{I}}_{1} - 3 ) ) - 1 \}$ $\begin{matrix}Strain energy function of Fung ' s type , \overline{ψ} = \frac{1}{2} c [ exp ( \overline{Q} ) - 1 ] , \\ \overline{Q} = {b}_{1} + {b}_{2} {\overline{E}}_{ZZ}^{2} + {b}_{3} {\overline{E}}_{RR}^{2} + 2 {b}_{4} {\overline{E}}_{ΘΘ} {\overline{E}}_{ZZ} + 2 {b}_{5} {\overline{E}}_{ZZ} {\overline{E}}_{RR} + 2 {b}_{6} {\overline{E}}_{RR} {\overline{E}}_{ΘΘ} + {b}_{7} {\overline{E}}_{Θ Z}^{2} + {b}_{8} {\overline{E}}_{RZ}^{2} + {b}_{9} {\overline{E}}_{R Θ}^{2}\end{matrix}$ $Strain energy function of Holzapfel et al . ( 2000 ) , \overline{ψ} = \frac{1}{2} c ( {\overline{I}}_{1} - 3 ) + \frac{{k}_{1}}{2 {k}_{2}} {\sum }_{i = 4 , 6} \{ exp [ {{k}_{2} ( {\overline{I}}_{i} - 1 )}^{2} ] - 1 \}$

Estimated stress related parameters for different arterial layers are provided in Table 5.

TABLE 5

| | Optimized parameters | | |
|---|---|---|---|
| Layer | c [kPa] | k₁ [kPa] | k₂ |
| Endothelium | 250.9108 | — | — |
| Intima | 270.9837 | 2.1492 | 1.3012 |
| IEL | 250.9108 | — | — |
| Media | 100.3643 | 3.5820 | 5.2049 |
| Adventitia | 10.0364 | 0.0716 | 0.9759 |

### 1. ANALYSIS

### 1.1. Structure of an Arterial Wall

Typical histological and anatomical structure of an arterial wall is shown in Ai and Vafai (2006). The arterial wall is composed of five layers. From the lumen side outward, the five layers of arterial wall are: endothelium, intima, internal elastic lamina (IEL), media, and adventitia. The innermost layer, endothelium, is a single layer of endothelial cells lining the interior surface of the artery which are in direct contact with the lumen and could be elongated in the same direction as the blood flow (Yang and Vafai, 2006). Intima, the innermost major layer, consists of both connective tissue and smooth muscle. Intima grows with age or disease and consequently might become more significant in predicting the mechanical behavior of an arterial wall. The internal elastic lamina separates the intima from the media. The media, the thickest layer, consists of alternating layers of smooth muscle cells and elastic connective tissue which gives the media high strength and ability to resist the load. The media layer is surrounded by loose connective tissue, the adventitia. The adventitia is the outermost layer of the arterial wall, which is composed of fibrous tissue containing elastic fibers, lymphatic, and occasional nutrient vessels. At high pressure levels, the adventitia behaves like a stiff tube to prevent the artery from rupture.

### 1.2. Stress and Strain Characteristics

Let's consider the body of an arterial wall in the reference configuration Ωₒ. A material particle point in the cylindrical coordinate system is represented as X(R,Θ,Z). After the arterial wall is deformed, the material point X(R,Θ,Z) transforms to a new position designated as x(r,θ,z). The transformation can be described by:

$$F = \frac{\partial x}{\partial X} \qquad Eq . ( 1 )$$

The deformation gradients can be used to describe the distance between two neighboring points in these two configurations and the Green-Lagrange strain tensor E can be introduced as:

$$E = \frac{1}{2} ( C - I ) \qquad Eq . ( 2 )$$

where the Green-Lagrange strain tensor E is given in terms of the right Cauchy Green tensor C, which is:

C=F^{T}F Eq. (3)

where I denotes the identity tensor.

The internal force within the deformed body per unit area can be represented as stress. To describe the hyperelastic stress response of an arterial wall, appropriate strain energy function ψ is chosen to describe its physical behavior. The force in the reference configuration Ωₒ to its area, known as the second Piola-Kirchhoff stress tensor s, could be determined by forming the first derivative of strain energy function ψ with respect to the Green-Lagrange strain tensor E as:

$$S = \frac{\partial ψ}{\partial E} . \qquad Eq . ( 4 )$$

The Piola-Kirchhoff stress tensor can be transformed onto the Cauchy stress tensor via the following relationship

σ=J⁻¹FSF^{T} Eq. (5)

where J denotes the Jacobian determinant of the deformation gradient tensor which must satisfy the conservation of mass.

The Cauchy stress tensor σ could be expressed as the sum of two other stress tensors: volumetric stress tensor σᵥₒₗ which tends to change the volume of the stressed body and the stress deviator tensor σ̅ which tends to distort the stressed body, i.e.,

σ=σᵥₒₗ+ σ̅. Eq. (6)

The equation of motion of a continuum derived by applying Newton's law can be expressed as:

$$\frac{\partial σ}{\partial x} + G = ρ a \qquad Eq . ( 7 )$$

where C denotes the body force within the arterial wall and a denotes its acceleration.

The conservation of mass is expressed by:

$$\frac{\partial ρ}{\partial t} + \frac{\partial ρ v}{\partial x} = 0 \qquad Eq . ( 8$$

where ρ denotes density of the arterial wall and v denotes its velocity vector.

The deformation of the arterial wall is related to the luminal pressure which in turn is due to the applied load by blood flow within the arterial lumen. The blood which can be represented as Newtonian fluid is described by the Navier-Stokes equation:

$$ρ \frac{\partial v}{\partial t} + ρ v . ∇ v = - ∇ p + μ {∇}^{2} v + f \qquad Eq . ( 9 )$$

where ρ denotes the density of blood, v, the velocity vector, ρ, the luminal pressure, μ, dynamic viscosity of blood, and f denotes the body force. Hence, the stress and strain distributions in an arterial wall can be computed and used for predicting an arterial rupture.

### 1.3. Computational Model

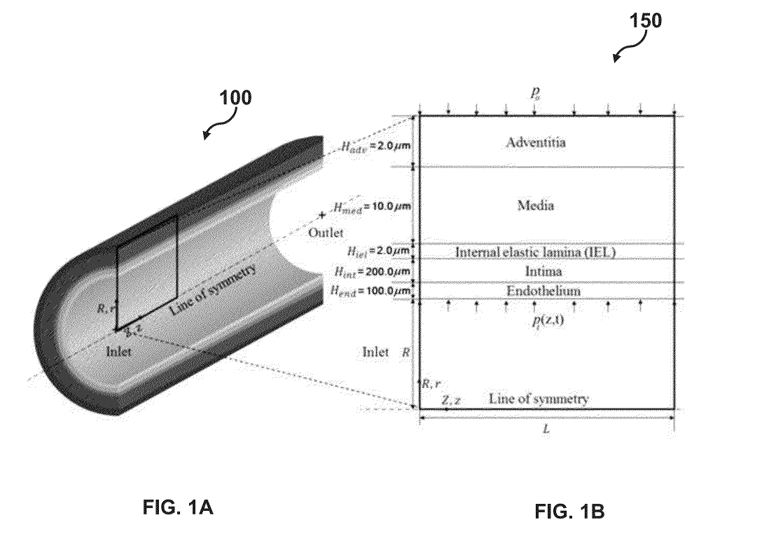

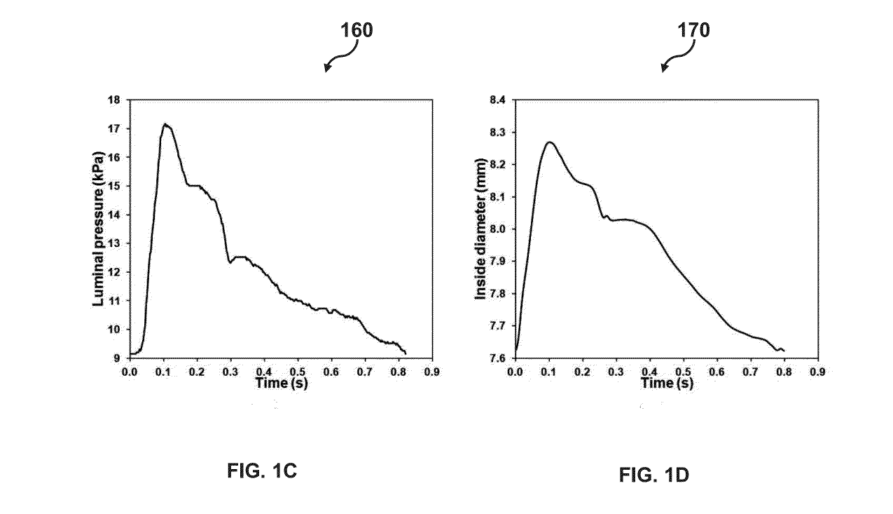

The schematic illustration 100 and 150 of the arterial geometry and boundary conditions under consideration is shown in FIGS. 1A-1B. The arterial geometry is represented by five concentric axisymmetric nonlinear elastic layers. The luminal radius, R was taken as 3.1 mm along with the longitudinal length L of 124 mm (Yang and Vafai, 2006). The thickness of each arterial wall layer is presented in FIG. 1A (Yang and Vafai, 2006, 2008; Ai and Vafai, 2006). It is assumed that the pressure is uniform in the circumferential direction. The pressure on the outer arterial wall is assumed to be uniform with magnitude of 4 kPa. The five layers of the arterial wall are sequential, i.e., the outside radius of an individual wall layer is the same as the inside radius of its outward neighbouring layer.

### 1.4. Mathematical Formulation

There are six regions in the present mechanical model, i.e. lumen and five arterial layers of endothelium, intima, internal elastic lamina, media, and adventitia. In what follows, the mathematical formulation for each layer is presented.

### 1.4.1. Lumen

The pressure profile from experimental data (N=5852) for a human carotid artery obtained by UEIL [Ultrasound and Elasticity Imaging Laboratory (UEIL) at the Biomedical Engineering and Radiology department of Columbia University, NY, US] is shown in FIG. 1C as graph 160. Blood flow is pulsatile and characterized by a parabolic velocity profile at the inlet of the arterial lumen. Considering an axisymmetric flow and neglecting the gravitational effect, the Navier-Stokes equations can be presented as:

$$\frac{\partial p}{\partial r} = 0 , \\ \frac{\partial p}{\partial θ} = 0 , \\ ρ \frac{\partial {u}_{2}}{\partial t} + {u}_{z} \frac{\partial {u}_{z}}{\partial z} = - \frac{\partial p}{\partial z} + μ \frac{{\partial }^{2} {u}_{z}}{\partial {r}^{2}} + μ \frac{{\partial }^{2} u}{\partial {z}^{2}} . \qquad Eq . ( 10 )$$

The time dependent outlet pressure, pₒᵤₜₗₑₜ(t) along a cardiac cycle could be obtained by curve fitting utilizing a Fourier approximation with mean squares error fit of a sinusoidal function with the experimental data for the pressure. So, the pressure within a cardiac cycle and its variation along the longitudinal direction, p(z,t), can be expressed as:

$$p ( z , t ) = ( \frac{2 μ {U}_{o}}{{R}^{2}} ( 1 + δsin ( \frac{2 π t}{T} ) ) ) ( {z}_{outlet} - z ) + ζ {A}_{o} + ξ {\sum }_{J = 1}^{30} {A}_{J} cos ( J \frac{2 π t}{T} ) + {B}_{J} sin ( J \frac{2 π t}{T} ) \qquad Eq . ( 11 )$$

where

$$μ = 0.0037 \frac{g}{mm . s} ,$$

Uₒ is the reference bulk inflow velocity,

$${U}_{o} = 169 \frac{mm}{s} ,$$

δ is the pulsatile flow parameter, δ=1, T cardiac period, T=0.8 s, parameters ζ and ξ are equal to unity, parameter Aₒ is 12011 Pa and A_{J} and B_{J} are given in Table 2.

### 1.4.2. Arterial Layers

The geometry and boundary conditions are shown in FIGS. 1A-1B. Kinematics of the artery in cylindrical coordinate system can be described as (Ai and Vafai, 2006; Yang and Vafai, 2008):

$$\begin{matrix}r = \sqrt{\frac{{R}^{2} - {R}_{i}^{2}}{k {λ}_{z}} + {r}_{i}^{2}} , & Eq . ( 12 ) \\ θ = k Θ + Z \frac{Φ}{L} , & Eq . ( 13 ) \\ z = {λ}_{z} Z & Eq . ( 14 )\end{matrix}$$

where

$$k = \frac{2 π}{2 π - α} ,$$

λ_{z} is the stretch ratio in longitudinal direction (Delfino et al., 1997), Φ and L are the opening angle and overall length of artery in the reference configuration and subscript i in Eq. (12) refers to the inner part of the artery. An artery deformed under extension and inflation and without residual strain is considered.

For endothelium and internal elastic lamina, the strain energy function of neo-Hookean has been used to determine the nonlinear response. The strain energy function for an incompressible neo-Hookean material is:

$${\overline{ψ}}_{j} = \frac{{c}_{j}}{2} ( {\overline{I}}_{1} - 3 ) \qquad Eq . ( 15 )$$

where cⱼ>0 is the stress-like parameter, Ī₁ is the first principal invariant of C̅ and subscript j refers to the endothelium and internal elastic lamina (IEL).

For intima, media, and adventitia, utilizing an artery structure composted of fibers and non-collagen matrix of material and fiber reinforced strain energy function suggested by Holzapfel et al. (2000) is suitable to relate stress and strain. This fiber reinforced strain energy function takes into account the architecture of the arterial wall and also requires a relatively small number of parameters (Khakpour and Vafai, 2008; Holzapfel et al., 2004b, 2005b). The strain energy function which will incorporate the isotropic and anisotropic parts can be written as:

$${\overline{ψ}}_{j} = \frac{{c}_{j}}{2} ( {\overline{I}}_{1} - 3 ) + \frac{{k}_{1 , j}}{2 {k}_{2 , j}} {\sum }_{i = 4 , 6} \{ exp [ {{k}_{2 j} ( {\overline{I}}_{ij} - 1 )}^{2} ] - 1 \} \qquad Eq . ( 16 )$$

where cⱼ>0, k₁ⱼ>0 are stress-like parameters and k_{2J}>0 is a dimensionless parameter, subscript j refers to intima, media, and adventitia layers, and subscript i refers to the index number of invariants. In Eq. (16), Ī₁ is the first principal invariant of C̅. The definitions of the invariants associated with the anisotropic deformation of arterial wall are given below:

Ī₄ⱼ= C̅:A₁ⱼ,Ī₆ⱼ= C̅:A₂ⱼ Eq. (17)

The collagen fibers normally do not support a compressive stress. Thus, in case of Ī₄≦1 and Ī₆≦1, the response is similar to the response of a rubber like material as described by Neo-Hookean functions. The tensor A₁ⱼ and A₂ⱼ characterizing the structure are given by:

A₁ⱼ=aₒ₁ⱼ [symbol] aₒ₂ⱼ, A₂ⱼ=aₒ₂ⱼ [symbol] aₒ₂ⱼ Eq. (18)

Components of the direction vector aₒ₁ⱼ and aₒ₂ⱼ in cylindrical coordinate system are:

$${a}_{o 1 j} = [ \begin{matrix}0 \\ cos {β}_{j} \\ sin {β}_{j}\end{matrix} ] , \\ {a}_{o 2 j} = [ \begin{matrix}0 \\ cos {β}_{j} \\ - sin {β}_{j}\end{matrix} ] \qquad Eq . ( 19 )$$

where βⱼ is the angle between the collagen fibers and circumferential direction. Three different values of 5, 7, and 49 degree (Holzapfel et al., 2002) are applied for the three major layers of intima, media, and adventitia, respectively.

Hence, the stress in Eulerian description could be determined by the expression given below:

$${\overline{σ}}_{j} = {c}_{j} dev \overline{b} + {\sum }_{i = 4 , 6} 2 {\overline{ψ}}_{ij} dev ( {a}_{ij} ⊗ {a}_{ij} ) \qquad Eq . ( 20 )$$

where

$$dev \overline{b} = \overline{b} - \frac{1}{3} [ \overline{b} : I ] I , \\ dev ( {a}_{ij} ⊗ {a}_{ij} ) = ( {a}_{ij} ⊗ {a}_{ij} ) - \frac{1}{3} [ ( {a}_{ij} ⊗ {a}_{ij} ) : I ] I ,$$

aᵢⱼ= F̅aₒᵢⱼ denotes the Eulerian counter part of aₒᵢⱼ and

$${\overline{ψ}}_{ij} = \frac{\partial {\overline{ψ}}_{aniso}}{\partial {I}_{ij}}$$

denotes a response function i.e. ψ̅₄ⱼ=k₁(Ī₄ⱼ−1)(exp(k₂(Ī₄ⱼ−1)²)) and ψ̅₆ⱼ=k₁(Ī₆ⱼ−1)(exp(k₂(Ī₆ⱼ−1)²)). Additionally, it should be noted that F=(J^{1/3}I) F̅, C̅= F̅^{T}F and b̅= F̅F̅^{T}. When incompressibility of an arterial wall is considered, F= F̅, C= C̅ and b= b̅ are obtained. There are only three parameters to be considered for each layer c, k₁, and k₂.

### 1.5. Determination of Constitutive Parameters

The diameter profile from experimental data (N=404) at carotid artery of human supported by UEIL (Ultrasound and Elasticity Imaging Laboratory (UEIL), Biomedical Engineering and Radiology, Columbia University, NY, US) are shown in FIG. 1D as graph 170. To obtain the diameter, the ultrasound probe is placed on the skin at the carotid position. The minima and maxima of the pressure and diameter waveforms are aligned and matched over the cardiac cycle. The viscosity effect is hence ignored. Arterial wall is considered as an incompressible material and horizontal so the gravity effect could be ignored, thus:

$$\frac{\partial σ}{\partial x} = 0. \qquad Eq . ( 21 )$$

Luminal pressure could be determined by:

$${p}_{i} = {\int }_{{r}_{i}}^{{r}_{o}} ( {\overline{σ}}_{θθ} - {\overline{σ}}_{rr} ) \frac{d r}{r} + {p}_{o} \qquad Eq . ( 22 )$$

where σ_{θθ}=P+ σ̅_{θθ}, σᵣᵣ=P= σ̅ᵣᵣ and P is the Lagrange multiplier used to enforce the incompressibility constraint.

Moving boundary has to be incorporated when analyzing the five-layer model. The moving boundary is normalized. Numerical integration with a three-point Gaussian quadrature which has an accuracy of the order of five is employed to discretize Eq. (22). Nonlinear least square method is used to estimate the relevant parameters by minimizing the mean square error MSEₚₐᵣ of luminal pressures (Objective function) given by:

$$M S {E}_{par} = \frac{1}{N} {\sum }_{i = 1}^{N} {( {p}_{i , model} - {p}_{i , experiment} )}^{2} \qquad Eq . ( 23 )$$

The Pearson product moment correlation coefficient rₚ through the data points in P_{i,model} and P_{i,experiment} is used to assess the strength of the fit. The equation for the Pearson product moment correlation coefficient is:

$${r}_{p} = \frac{{\sum }_{i = 1}^{N} ( {p}_{i , model} - {\overline{p}}_{i , model} ) ( {p}_{i , experiment} - {\overline{p}}_{i , experiment} )}{\sqrt{{\sum }_{i = 1}^{N} {( {p}_{i , model} - {\overline{p}}_{i , model} )}^{2} {\sum }_{i = 1}^{N} {( {p}_{i , experiment} - {\overline{p}}_{i , experiment} )}^{2}}} \qquad Eq . ( 24 )$$

where N is the number of longitudinal data points and i is the index for the summation over the whole data points.

### 1.6. Arterial Rupture

If the pressure is high and the artery has an inappropriate deformation, the rupture of the arterial wall could occur. There are a number of researchers who have studied the ultimate tensile stress and associated stretch in a normal human artery (Holzapfel, 2001; Zohdi et al., 2004; Franceschini et al., 2006; Sommer et al., 2008; Mohan and Melvin, 1982, 1983). In the past decade, ultimate values of separated layers has been studied (Sommer et al., 2008; Holzapfel et al., 2005a&b, 2004a; Holzapfel, 2009; Zhao at al., 2008; Sommer, 2010). The ultimate tensile stress and associated ultimate stretch (Holzapfel et al., 2004b) shown in Table 3 in circumferential and longitudinal directions for intima, media, and adventitia are used as criteria for assessing the rupture of the arterial wall in the present invention.

The equivalent tensile stress σᵥ and strain Eᵥ could be computed from the Cauchy stress tensor and the Green-Lagrange strain tensor as:

$$\begin{matrix}{σ}_{v} = \sqrt{\frac{3}{2} ( σ : σ - \frac{{( tr σ )}^{2}}{3} )} & Eq . ( 25 ) \\ {E}_{v} = \sqrt{\frac{3}{2} ( E : E - \frac{{( tr E )}^{2}}{3} )} & Eq . ( 26 )\end{matrix}$$

The ultimate tensile stress and the associated ultimate stretch in Table 3 are determined for critical equivalent tensile stress σ_{vj,cri} and strain E_{vj,cri}. Two strategies are investigated to identify the rupture area of the arterial wall. The first strategy is based on strain values. The area of arterial wall where the local equivalent strain exceeds the critical values is defined to be a rupture area. The second strategy is based on the tensile stress. The area of the arterial wall where the local equivalent tensile stress and the associated local equivalent strain exceed the critical values is defined to be the rupture area. Estimation of the rupture risk is referred to as the local equivalent of stress and strain approach. The percentage of the rupture risk of the arterial wall Pᵣᵢₛₖ is defined as:

Pᵣᵢₛₖ=100σⱼ*Eⱼ* Eq. (27)

where σⱼ* and Eⱼ* are normalized values which can be presented as:

$$\begin{matrix}{σ}_{j}^{*} \{ {σ}_{j}^{*} \vert if \frac{{σ}_{v}}{{σ}_{vj , cri}} < 1 , {σ}_{j}^{*} = \frac{{σ}_{v}}{{σ}_{vj , cri}} ; if \frac{{σ}_{v}}{{σ}_{vj , cri}} \geq 1 , {σ}_{j}^{*} = 1 \} , & Eq . ( 28 ) \\ {E}_{j}^{*} \{ {E}_{j}^{*} \vert if \frac{{E}_{v}}{{E}_{vj , cri}} < 1 , {E}_{j}^{*} = \frac{{E}_{v}}{{E}_{vj , cri}} ; if \frac{{E}_{v}}{{E}_{vj , cri}} \geq 1 , {E}_{j}^{*} = 1 \} & Eq . ( 29 )\end{matrix}$$

Due to lack of data for endothelium and internal elastic lamina (IEL) layers, critical values for intima are applied for these two layers.

### 2. RESULTS AND DISCUSSION

2.1. Comparison with Previous Studies

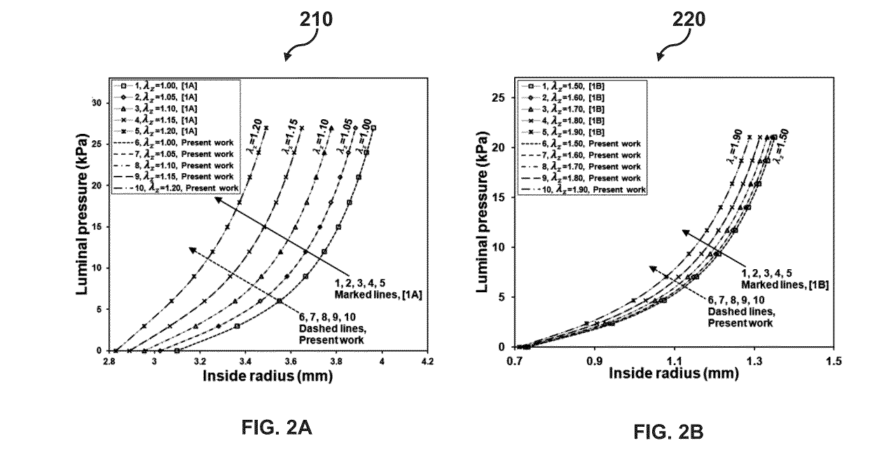

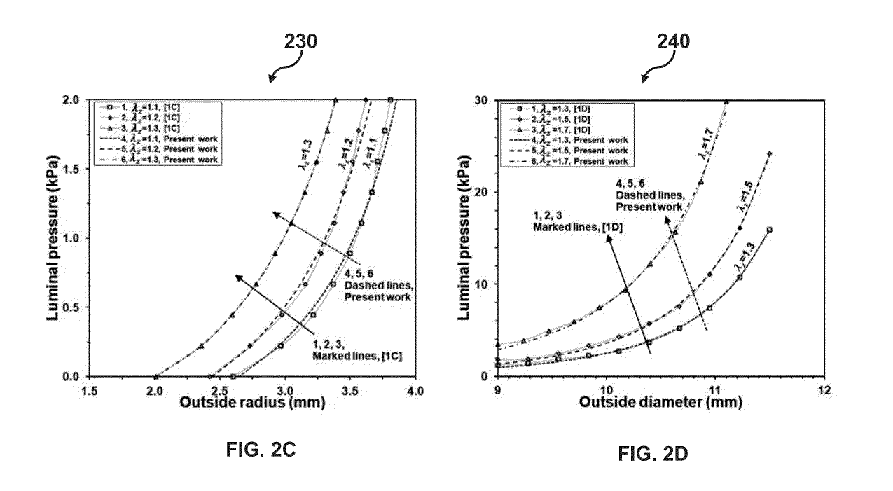

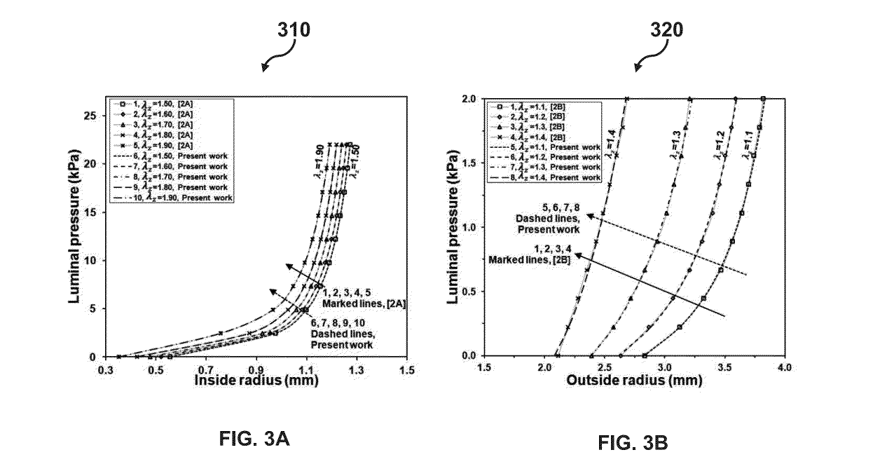

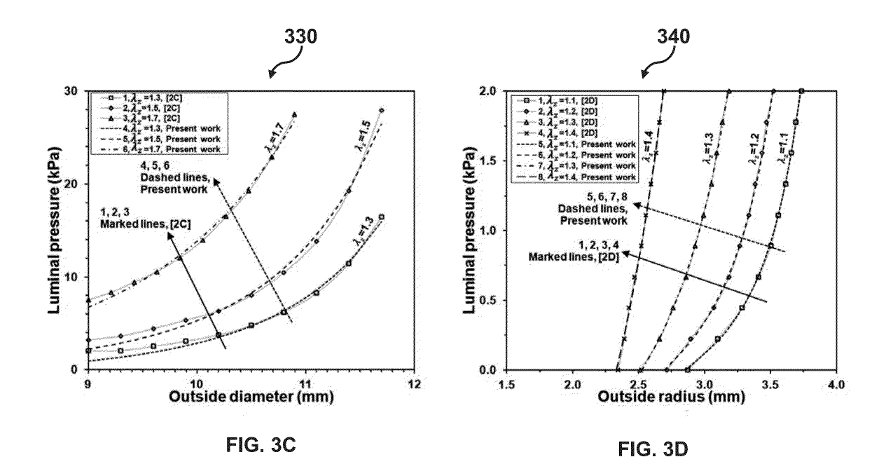

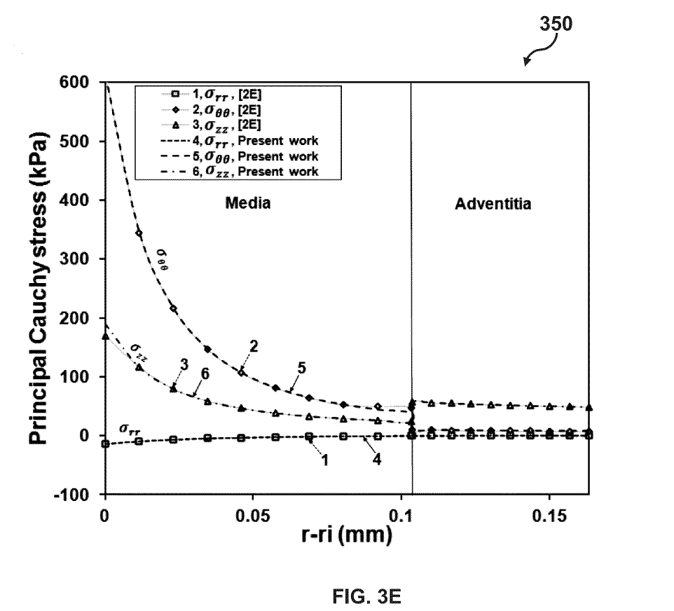

The present invention employs two constitutive equations and incorporates a five-layer arterial wall model in three-dimensions based on in vivo non-invasive experimental data for a human artery. The computational model is compared to a number of prior studies for one and two-layer material models by using their constitutive equations and material parameter sets in in-house computational program. The comprehensive model is compared with the pertinent results in the literature in FIGS. 2A-2D and FIGS. 3A-3E. This constitutes a detailed set of nine comparisons which are highlighted in Table 4. The source of comparison, constitutive equations and utilized parameters for these comparisons are given in Table 4.

The graphs 210, 220, 230, and 240 in FIGS. 2A-2D displays four comparisons for the one-layer model computed by the computational program representing the luminal pressure versus inner and outer radii with prior works (Cases 1A, 1B, 1C & 1D shown in Table 4). The simulations are found to be in very good agreement with previous studies. Slight differences in the results occur due to different solution methodologies.

The graphs 310, 320, 330, 340, and 350 in FIGS. 3A-3E displays five comparisons for the two-layer model computed by computational model representing luminal pressure versus inner and outer radii (Cases 2A, 2B, 2C & 2D) and the principal Cauchy stresses across arterial wall (Case 2E). Again, very good agreement with prior works is observed. The computational program is extended to calculate the stress and strain distributions across inflated and extended arterial wall incorporating the five-layer three-dimensional model. The obtained results are analyzed to investigate circumstances under which the arterial wall will rupture.

### 2.2. Parameter Estimation

The estimated parameters are shown in Table 5 and the Pearson product moment correlation coefficient rₚ, of 0.97 is obtained. Using these estimated parameter sets, the strain energy density contours in circumferential and longitudinal directions are investigated for each of the arterial layers.

### 2.3. Effects of Pressure on Arterial Rupture

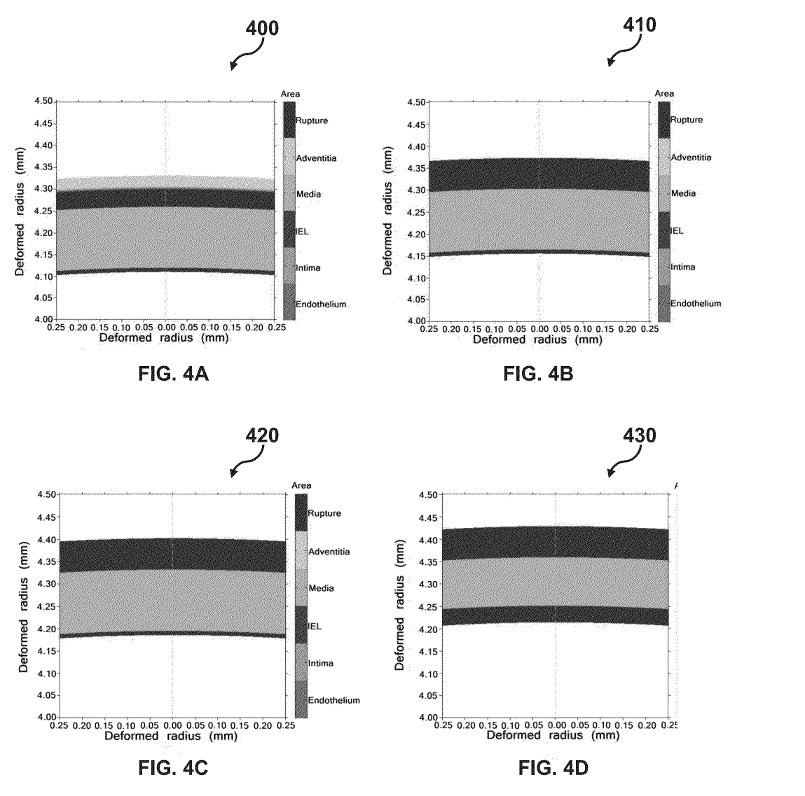

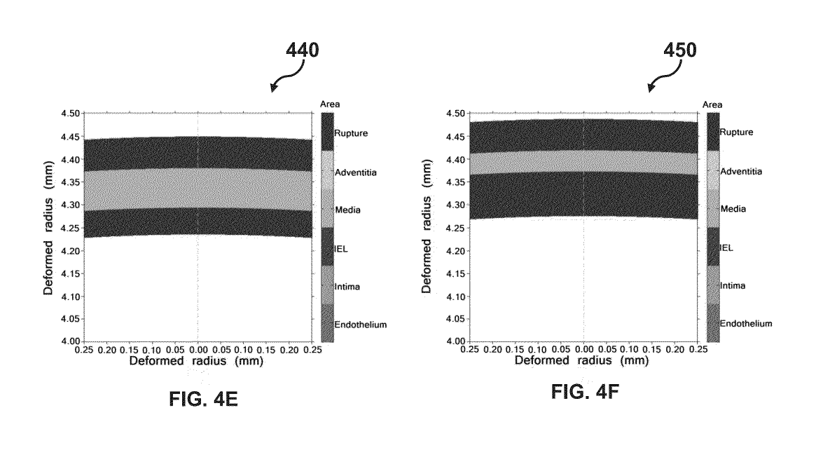

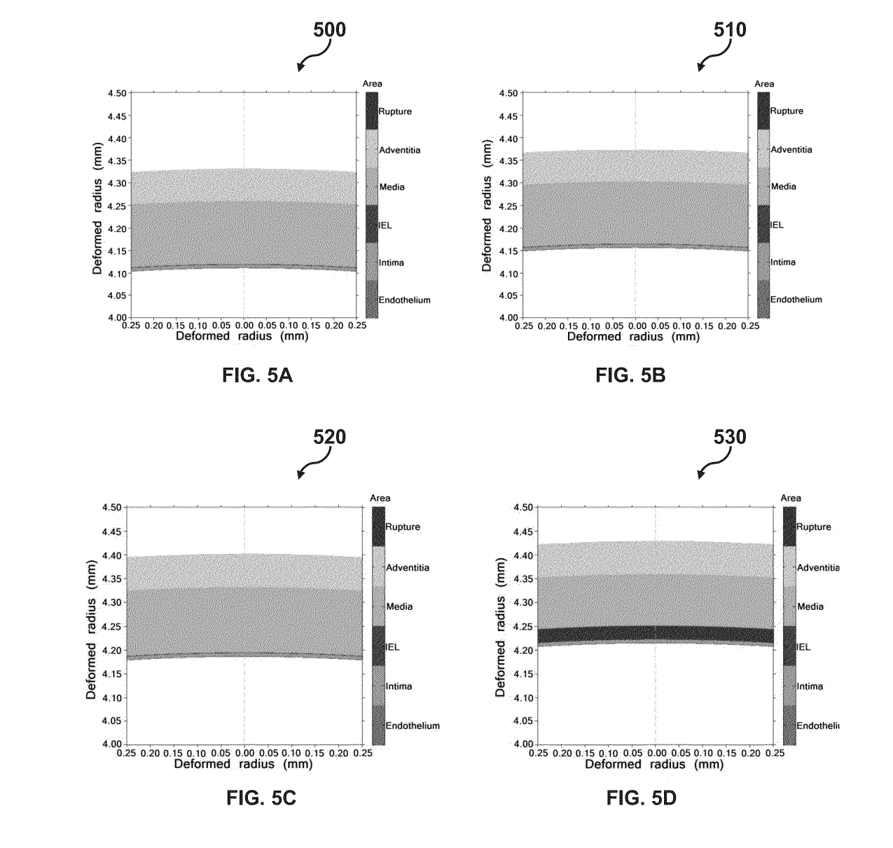

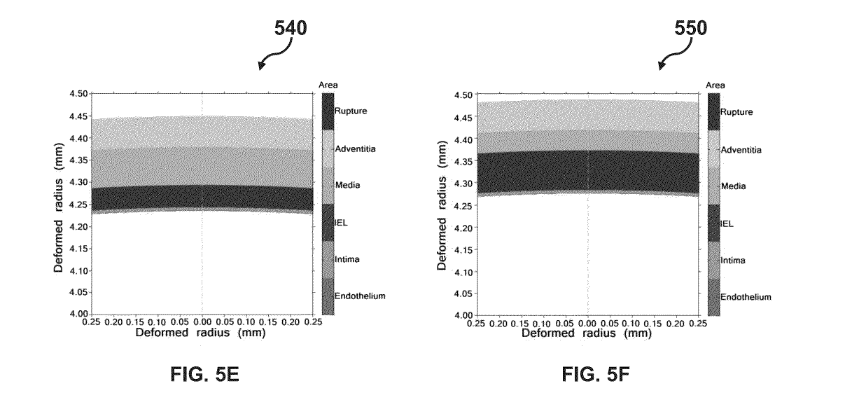

FIGS. 4A-4F illustrate graphs 400, 410, 420, 430, 440, and 450 showing rupture characteristics of an arterial wall based on utilizing strain as a criterion with wall deformation in the r-θ plane at luminal pressure of 16.0, 18.7, 21.3, 24.0, 26.7, and 33.3 kPa, respectively. The pressure load acting on the inner surface of the arterial wall increases the associated strain continually to the point of failure. Deformation of the arterial wall could be presented directly by displaying the strain distribution. As such the strain distribution can be used to identify the rupture area. FIGS. 5A-5F illustrate graphs 500, 510, 520, 530, 540, and 550 showing rupture characteristics of an arterial wall based on using stress and strain as a criterion with wall deformation in the r-θ plane at luminal pressure of 16.0, 18.7, 21.3, 24.0, 26.7, and 33.3 kPa, respectively. The rupture area can be identified using both the stress and strain distributions such as the results presented in FIGS. 5A-5F.

From the result shown in FIGS. 5A-5F the rupture characteristics can be qualitatively interpreted. The failure process can be separated into two regimes, failure initiation and failure propagation. The existence and extent of the failure initiation and propagation depends on the pressure or stress which relates to the arterial geometry or strain by the properties of each arterial layer. It could be seen that the rupture occurs in the circumferential direction around the arterial wall and the rupture initiates a tear at the medial surface of the artery. Moreover, the rupture propagates from inside the medial surface towards the outer surface.

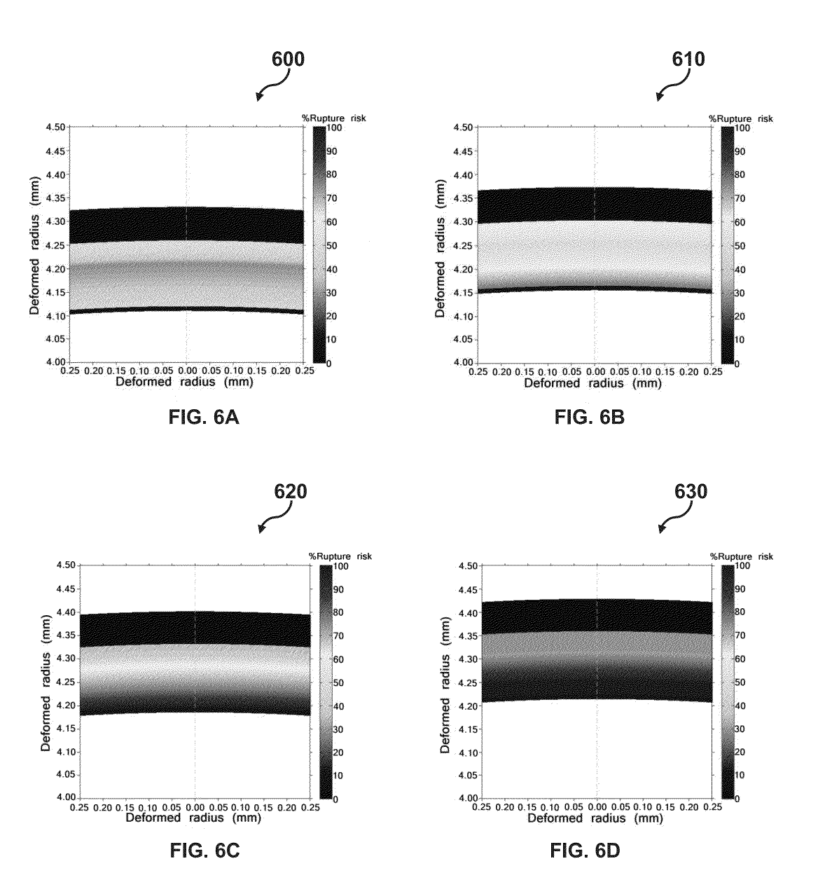

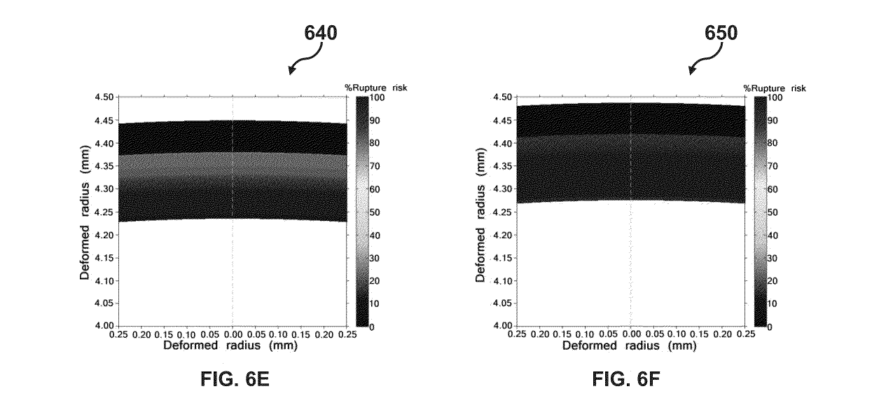

FIGS. 6A-6F illustrate graphs 600, 610, 620, 630, 640, and 650 showing percentage risk of rupture of an arterial well based on using stress and strain as a criterion with risk percentage of rupture in the r-θ plane at luminal of 16.0, 18.7, 21.3, 24.0, 26.7 and 33.3 kPa, respectively. In order to quantitatively interpret the effect of pressure on arterial failure, an assessment is made regarding the percentage for the risk of rupture. The percentage for the risk of rupture is displayed in FIGS. 6A-6F. The risk level is divided into five groups. First, the normal pressure level is when the pressure is lower than 16.0 kPa. In the normal pressure level range, it is found that maximum percentage risk of rupture does not exceed 50% (FIG. 6A). The second level, pre-high pressure level is when the pressure is in the range of 16.0 kPa to 18.7 kPa. At pre-high pressure level, maximum risk percentage of rupture is much greater but does not exceed 80% (FIG. 6B). Next, high pressure level is when the pressure is in the range of 18.7 kPa to 21.3 kPa. At this level, maximum risk percentage of rupture is quite high but rupture is not eminent (FIG. 6C). The rupture initiation and propagation occurs within the severe pressure level which is between 21.3 and 26.7 kPa (FIGS. 6D and 6E). The rupture initiation occurs at about 24.0 kPa.

The present invention has explored a comprehensive model based on in vivo non-invasive experimental data to identify rupture area and estimate the risk percentage of rupture in normal five-layer arterial wall. The major advantages of the present model is that it incorporates the architecture of arterial layers by using two suitable forms of constitutive equations to describe the mechanical attributes. In addition, the luminal pressure variations resulting from the luminal blood flow is also included.

### 3. CONCLUSIONS

The effects of pressure on arterial failure have been investigated based on a comprehensive three-dimensional five-layer arterial wall model. The endothelium and internal elastic lamina are treated as isotropic media and intima, media, and adventitia are treated as anisotropic media incorporating the active collagen fibers. Layered arterial wall is modelled using two types of constitutive equations. The comprehensive model was found to be in very good agreement with the results from the prior studies. The effects of pressure on arterial failure are examined in detail. The present investigation demonstrates that the pressure is mainly responsible for the concentric wall movement. The present work incorporates the three-dimensional five-layer model and predicts the propagated rupture area of the arterial wall coupled with blood flow in the lumen.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing the effect of pressure on arterial failure, comprising:
incorporating three-dimensional effects within a plurality of concentric axisymmetric layers while incorporating nonlinear elastic characteristics under combined extension and inflation;
employing constitutive equations for fiber-reinforced material for three of the major layers;
employing an isotropic material model for at least two other layers;
utilizing a three-dimensional five-layer model to model propagated rupture area of arterial wall;
obtaining required parameters for each layer using nonlinear least square method fitted to in vivo non-invasive experimental data of human artery; and
examining effects of pressure on arterial failure.

2. The method of claim 1 further comprising providing local stresses and strain distributions across the deformed arterial wall and consequently predicting rupture area by varying luminal pressure in the physiological range and beyond.

3. The method of claim 1 further comprising interpreting effects of pressure on the arterial failure based on said three-dimensional five-layer model.

4. The method of claim 1 further comprising employing two constitutive equations and incorporating a five-layer arterial wall model in three-dimensions based on in vivo non-invasive experimental data for a human artery.

5. The method of claim 1 wherein said three of the major layers comprises intima, media, and adventitia.

6. The method of claim 1 wherein said other two layers comprises endothelium and internal elastic lamina.
